(19) United States
(12) Patent Application Publication
(10) Pub. No.: US 2014/0054213 A1
(43) Pub. Date: Feb. 27, 2014

(54) STACKING PORTABLE WATER FILTER

(71) Applicants: Rui Yuan Chen, Singapore (SG); Brian F. Rutledge, Kissimmee, FL (US)

(72) Inventors: Rui Yuan Chen, Singapore (SG); Brian F. Rutledge, Kissimmee, FL (US)

(21) Appl. No.: 13/594,084

(22) Filed: Aug. 24, 2012

(51) Int. Cl. B01D 29/00

(52) U.S. Cl. CPC B01D 23/02
USPC 210/469

(57) ABSTRACT

A stacking portable water filter includes an upper and a lower canister, with the lower canister having a filter aperture which receives a filter cartridge therein. Untreated water received in the upper canister flows through the filter cartridge by gravity to be collected in the lower canister. Both canisters include an upper rim, with both upper rims having a substantially similar size and shape. A cover is also provided to fit on one or the other of the rims. In an operative positions with the containers stacked, the cover may mount to the upper rim of the upper canister. In a portable position with the upper canister removed from the lower canister, the cover may be mounted to the upper rim of the lower canister.

### CROSS REFERENCE TO RELATED APPLICATIONS

This application is related to co-pending attorney reference number 131674-D 200, which is incorporated by reference herein and b-day party here, including but not limited to those portions which specifically appear hereinafter.

### STATEMENT REGARDING FEDERALLY SPONSORED RESEARCH

Not applicable.

### BACKGROUND OF THE INVENTION

The present invention relates in general to household water filters. In particular, the present invention relates to an improved gravity water filter which has a large capacity, is selectively sealed for protection, and which may be easily disassembled for travel.

It is common for households to desire to filter water for improved purity. This desire may be solely for drinking water, but may also extend to water to be used for cooking as well. Various types of water filters are known, with gravity filters employing replaceable cartridges being quite popular. These most commonly take the form of a pitcher. While these are suitable for certain lifestyles, they have a limited storage capacity, and are not well suited for portability out of the home.

### SUMMARY OF THE INVENTION

An object of the present invention is to provide a gravity water filter having a large storage capacity.

Another object of the present invention is to provide a water filter having a sealing cover to prevent contamination of the interior.

A further object of the present invention is to provide a water filter which may be easily portable.

These and other objects are achieved by a stacking portable water filter. The water filter includes an upper canister and a lower canister. The upper canister includes an aperture in the bottom wall to receive a filtering cartridge. The upper canister may rest upon the lower canister such that water received within the upper canister will flow through the cartridge to be received within the lower canister. A spigot is provided in the lower canister for dispensing water therefrom. Each of the upper and lower canisters includes an upper rim. There is also provided a cover which may be sealed to the upper rim of the upper canister to prevent contamination of the interior. The upper rim of the lower canister is substantially identical to that of the upper canister such that the cover may be selectively sealed to the upper rim of the lower canister as well. The upper and lower canisters may be stacked together in an operative position for filtering water with the cover selectively sealed to the upper canister, thus protecting the water to be filtered or the cartridge. If it is desired to move the water to a different location the upper canister may be disassembled from the operative position and the cover may be selectively sealed to the upper rim of the lower canister. T cover will prevent loss of the filtered water from the lower canister during travel as well as protect from contamination. A pressure relief valve may be provided in the cover to allow proper flow of the water during filtering or dispensing.

### BRIEF DESCRIPTION OF THE DRAWINGS

The objects and features of the invention noted above are explained in more detail with reference to the drawings, in which like reference numerals denote like elements, and in which:

FIG. 1 is a top perspective view of the stacking portable water filter according to the present invention in the operative configuration;

FIG. 2 is a side cross-sectional view along line 2-2 of FIG. 1 with the cartridge removed for clarity;

FIG. 3 is an exploded bottom perspective view thereof;

FIG. 4 is a top perspective view of the lower canister with cover in the portable configuration;

FIG. 5 is a detailed cross-sectional view a long line 2-2 showing a first embodiment of a pressure relief valve; and

FIG. 6 is a detailed cross-sectional view a long line 2-2 of a second embodiment of a pressure relief valve.

### DETAILED DESCRIPTION OF THE INVENTION

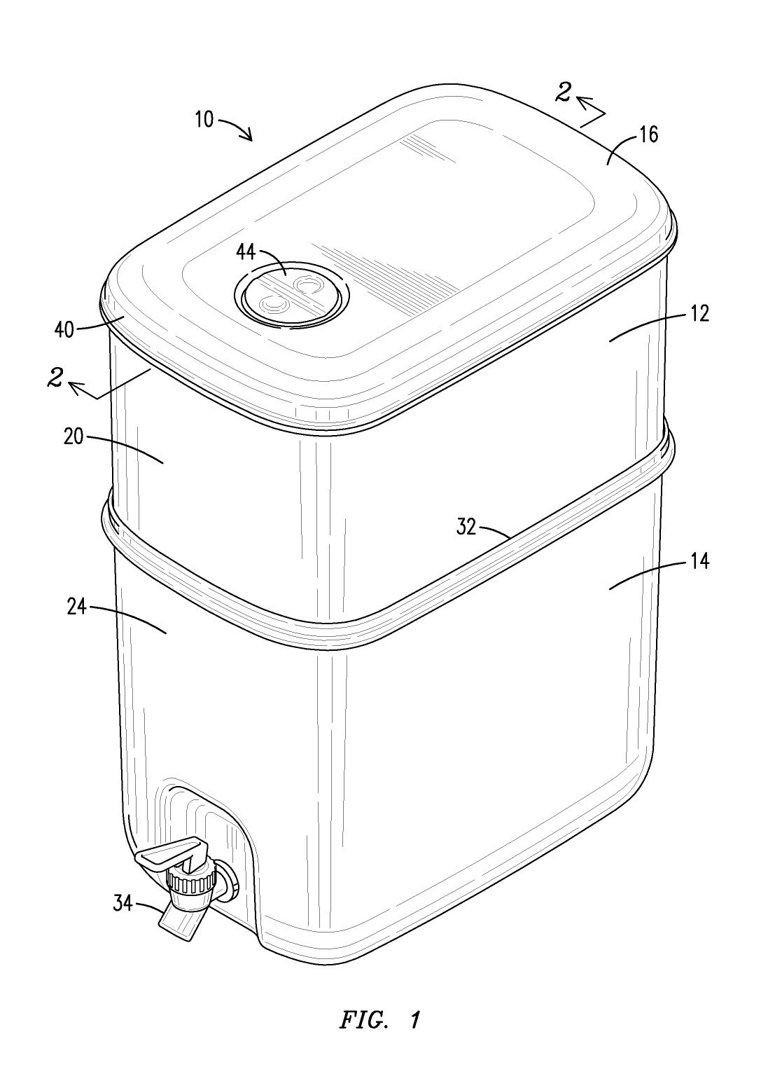

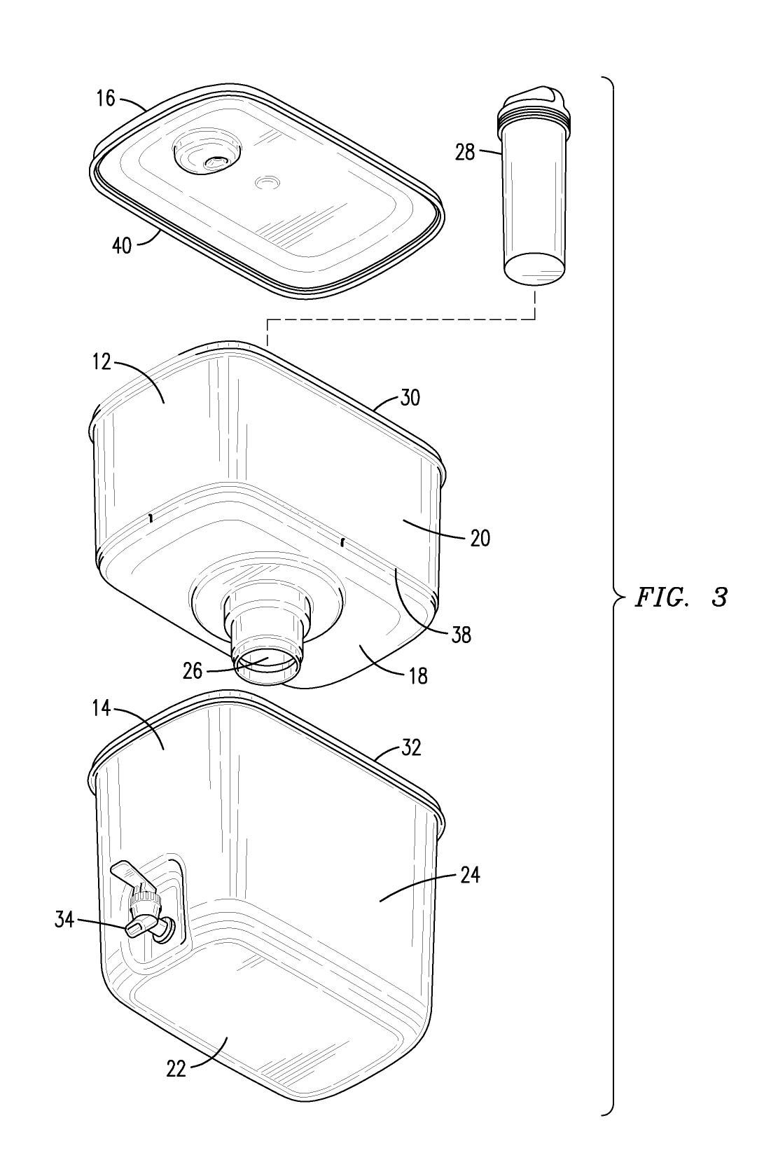

With reference to FIG. 1, a stacking portable water filter according to the present invention is generally designated by reference numeral 10. The filter 10 generally includes an upper canister 12, a lower canister 14, and a cover 16. As best shown in FIG. 3, both canisters take the general form of a tub, with a bottom wall and at least one side wall extending upward from the periphery of said bottom wall. In particular, upper canister 12 includes a bottom wall 18 and a side wall 20 extending upward therefrom, while lower canister 14 includes a bottom wall 22 and a side wall 24 extending upward therefrom. The side walls 20 and 24 will each end at a free edge or rim 30 and 34, respectively. While various materials could be used, it is preferred that each of the canisters 20 and 22 be formed as a monolithic plastic item.

In the embodiment shown, the peripheries of the bottom walls 18 and 22 are both generally rectangular. Other shapes may be employed as desired, such as round, oval, triangular, etc. With a round or oval bottom wall periphery the associated side wall extending therefrom would be a single continuous wall. For bottom wall peripheries having three or more clearly defined edges there would be a like number of clearly defined side walls. It is for this reason that the canisters 12 and 14 are indicated to have “at least one” side wall. In the embodiment shown the bottom walls 18 and 22 are shown with rounded corners such that a single continuous side wall is formed (with flattened areas longitudinally and laterally).

As shown the bottom walls 18 and 22 both have a similar shape. While this is preferred, this is not required and the bottom walls 18 and 22 could have different shapes. For example, the bottom wall 18 could be circular, while the bottom wall 22 is square.

As is best shown in FIG. 3, the bottom wall 18 of upper canister 12 includes a cartridge aperture 26 extending therethrough, sized and shaped to receive therein a filter cartridge 28. The filter cartridge 28 will allow the passage of water therethrough, and will contain various prior art materials to filter and/or treat the water passing through the cartridge in the manner desired. These materials form no part of this invention. As is known in the prior art, this material to filter or treat the water will typically have a limited useful life, and as such the filter cartridge 28 will typically be a replaceable item.

During water filtration the cartridge 28 will be received within the cartridge aperture 26. It is important that the fit of the cartridge 28 within the aperture be water tight to prevent untreated water from bypassing the filter cartridge. This may be achieved by any arrangement known in the art. In the embodiment shown, the cartridge aperture takes the form of an elongated tube having stepped shoulders which will mate with stepped shoulders on the filter cartridge 28, together with one or more elastic O-rings mounted about the cartridge 28 so as to abut and seal against the cartridge aperture 26.

In an operative position for water filtration shown in FIGS. 1-3 the upper canister 12 will be mounted upon the lower canister 22 with the cartridge aperture 26 (and outlet of the filter cartridge 28) within the opening formed by lower rim 32. In this manner untreated water received within the upper canister 12 will flow through the filter cartridge 28 and this newly treated water will be collected within the lower canister 14. It is preferred that the lower canister 14 include some means for dispensing the treated water collected therein, such as a spigot 34.

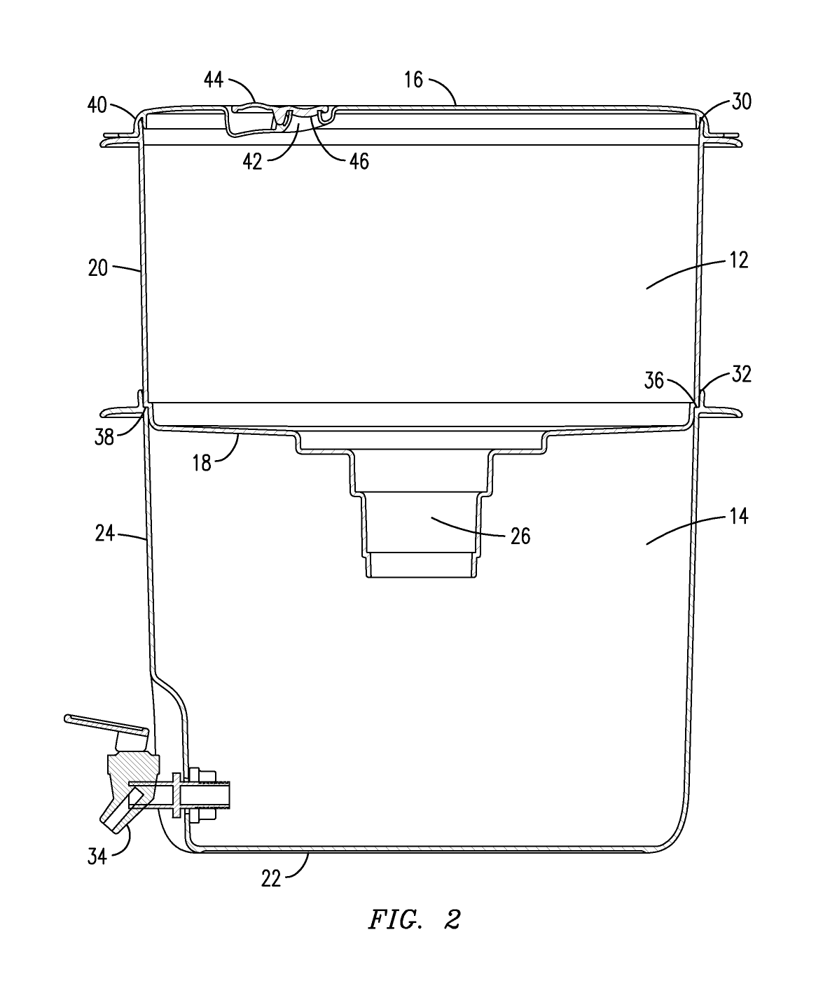

The mounting of the upper canister 12 to the lower canister 14 could be by various arrangements known in the prior art. In the preferred arrangement shown, the interior edge of the lower rim 32 includes an upwardly facing reduced-periphery rim shoulder 36, and the upper canister 12 rests upon this shoulder 36. In particular the outer periphery of bottom wall 18 may rest upon shoulder 36 (not shown), or the side wall 20 may include a downwardly-facing peripheral mating shoulder 38 which rests upon the rim shoulder 36. This is best shown in FIG. 2. It is most preferred that the mounting arrangement substantially cover the entire opening formed by lower rim 32 so as to prevent ingress of material which might contaminate the treated water collected within lower canister 14. As such, it is preferred that the shoulders 36 and 38 be of closely similar size and shape so as to form no gaps.

While it is common in the prior art for the equivalent of the upper canister to be fully received within the equivalent of the lower canister, this is not preferred for the present invention. Instead it is preferred that in the operative position the upper canister 12 be mounted to the lower canister 14 such that the bottom wall 18 of the upper canister is closely adjacent to the rim 32 of the lower canister 14 and the rim 30 of upper canister 12 is spaced upwardly from rim 32 of the lower canister 14 (preferably by substantially the entire height of the upper canister 12). With this arrangement the upper canister 12 occupies very little of the interior space of the lower canister 14, thus increasing the storage capacity of the water filter 10.

As noted previously, the filter 10 includes a cover 16. The cover 16 is sized and shaped to at least rest upon the rim 30 of upper canister 12 and close the opening formed by rim 30. While simple resting would be sufficient, it is preferred that the cover 16 seal to the rim 30. This may be by various arrangements, but preferably the cover 16 would be formed as a plastic unit having a monolithic skirt 40 which closely grips rim 30 in a manner similar to known plastic storage containers.

As may be envisioned, if the bottom wall 18 of the upper canister 12 is closely adjacent the rim 32 of the lower canister 14 in the operative position, the filter 10 will be top-heavy at the start of the filtering process, and more prone to tipping over. To reduce possible spillage in the event of the upper canister 12 or the entire filter 10 were to tip over, it is preferred that the seal of the cover 16 to the upper canister rim 30 be a water-tight seal. Such a seal, however, may result in a buildup of negative pressure within the upper canister 12 as the untreated water exits the upper canister 12. To solve this problem, it is preferred that the one of the side wall 20 or cover 16 include a pressure relief valve. In the preferred embodiment of FIGS. 1-5, the pressure relief valve takes the form of a relief aperture 42 extending through the cover 16 and a toggle 44 having a snap plug 46 of the type shown in US (INSERT PRIOR ART PATENT NUMBER). As is known in the prior art, the toggle 44 may be selectively moved by manual pressure between a closed position in which the snap plug 46 closes relief aperture 42 with a water-tight friction fit, and an open position in which the snap plug 46 is removed from the relief aperture 42 to allow air to freely enter the interior of upper canister 12. As an alternative example of a pressure relief valve, FIG. 6 shows a silicone duckbill valve 48 of the type known in the prior art inserted within a mounting aperture 50 in the cover 16.

The filter 10 as described may be seen to provide a gravity water filter system having a large capacity, and with feature for the protection of both the untreated and treated water from outside contamination. Configured in the operative position of FIGS. 1-3 the filter 10 may filter and/or dispense the water in a typical home setting. A further feature of the present invention is the selective reconfiguration of the filter 10 for portability to a different location, such as an outdoor party.

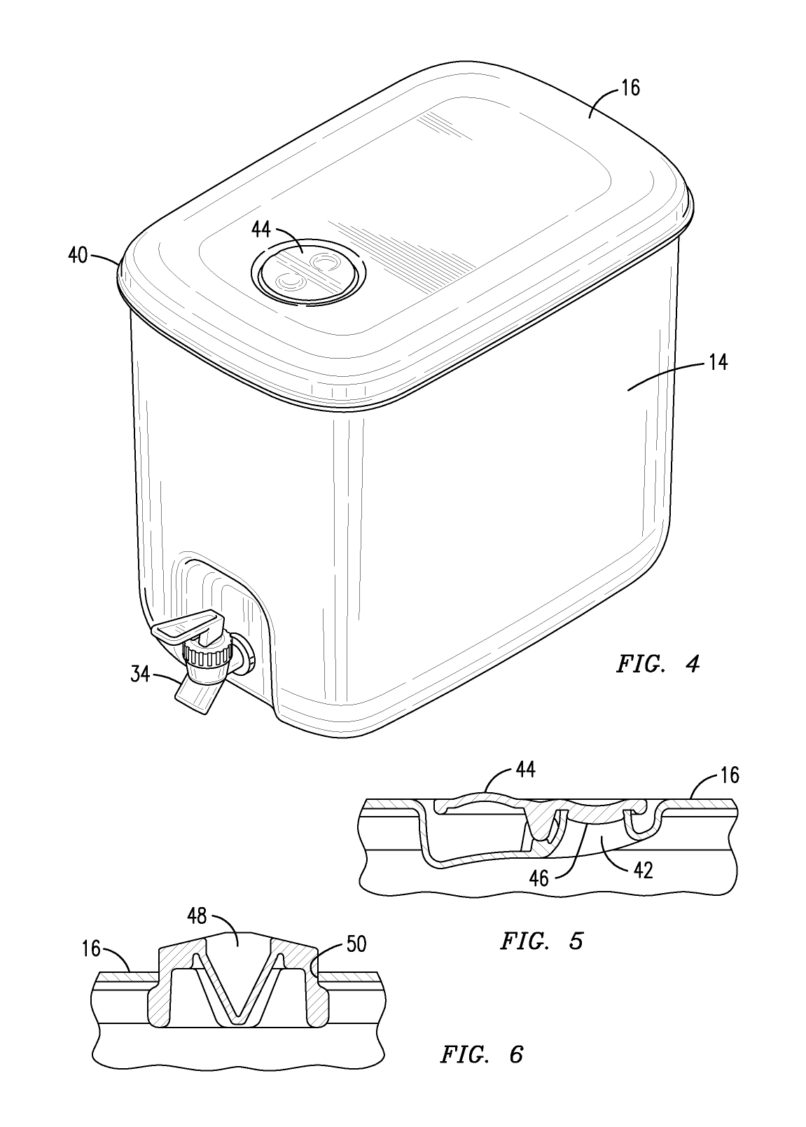

In particular, the filter 10 is preferably constructed in a way to permit the upper canister 12 to be removed from the lower canister 14 and placed into storage together with the filter cartridge 28, and the cover 16 to be mounted upon the lower canister 14. This is shown in FIG. 4 and is referred to as the portable position.

To permit the cover 16 to selectively mount to either the upper canister rim 30 or the lower canister rim 32, it is important that both rims 30 and 32 have substantially identical sizes and shapes. In this manner, the cover 16 may be formed to seal to the rim 30 in the operative position as described above, and then also seal to the rim 32 in the portable position. The cover 16 will thus serve to protect the treated water in lower canister 14 from contamination, as well as to prevent spilling during transport of the lower canister. If the cover 16 is formed with the water-tight seal, dispensing of treated water from the spigot 34 may result in negative pressure within the lower canister 14. This problem would be solved also by the pressure relief valve formed in the cover 16 described above.

As may be seen, the filter 10 according to the present invention provides selective manual configuration between an operative position and a portable position. In the operative position the filter 10 provides a large filtering capacity due to its stacking arrangement with the upper canister bottom wall 18 closely adjacent to the lower canister rim 32. Further, forming both rims 30 and 32 with substantially similar shapes and sizes allows a single cover 16 to be selectively mounted to either the upper canister 12 or the lower canister 14, even with a water-tight seal. Finally, providing a pressure relief valve within the cover 16 eliminates negative pressure within which ever canister the cover is mounted to.

From the foregoing it will be seen that this invention is one well adapted to attain all ends and objects set forth above together with the other advantages which are inherent within its structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth of shown in the accompanying drawings is to be interpreted as illustrative, and not in a limiting sense.

What is claimed is:

1. A water filter, comprising:
a lower canister having a bottom wall and at least one side wall extending upwardly from a periphery of said bottom wall to an upper rim;
an upper canister having a bottom wall and at least one side wall extending upwardly from a periphery of said upper canister bottom wall to an upper rim, both said upper rims having a size and shape which is substantially identical, said upper canister bottom wall including a canister aperture extending therethrough sized to receive a filter cartridge therein; and
a cover;
wherein said upper canister, lower canister and cover are selectively assembled between:
an operative position with said upper canister resting upon said lower canister and said cover mounted to said upper canister upper rim; and a portable position with said upper canister removed from said lower canister and said cover mounted to said lower canister upper rim.

2. A water filter as in claim 1, wherein said mounting of said cover to said upper rims is in both positions a water-tight mounting.

3. A water filter as in claim 2, wherein in said operative position said bottom wall of said upper canister is closely adjacent said upper rim of said lower canister.

4. A water filter as in claim 2, wherein in said operative position said upper rim of said upper canister is spaced upwardly from said upper rim of said lower canister.

5. A water filter as in claim 4, wherein in said operative position said bottom wall of said upper canister is closely adjacent said upper rim of said lower canister.

6. A water filter, comprising:
a lower canister having a bottom wall and at least one side wall extending upwardly from a periphery of said bottom wall to an upper rim;
an upper canister having a bottom wall and at least one side wall extending upwardly from a periphery of said upper canister bottom wall to an upper rim, said upper canister bottom wall including a canister aperture extending therethrough sized to receive a filter cartridge therein; and
a cover;
wherein said upper canister, lower canister and cover are selectively assembled between:
an operative position with said upper canister resting upon said lower canister with said upper rim of said upper canister spaced upwardly from said upper rim of said lower canister and said cover mounted to said upper canister upper rim; and a portable position with said upper canister removed from said lower canister and said cover mounted to said lower canister upper rim.

7. A water filter as in claim 6, wherein in said operative position said bottom wall of said upper canister is closely adjacent said upper rim of said lower canister.

8. A water filter as in claim 7, wherein said mounting of said cover to said upper rims is in both positions a water-tight mounting.
